(19) United States
(12) Patent Application Publication
(10) Pub. No.: US 2010/0058683 A1
(43) Pub. Date: Mar. 11, 2010

(54) Adjustable sill pan assembly and system

(75) Inventor: Todd E. Bushberger, West Allis, WI (US)

Correspondence Address: BOYLE FREDRICKSON S.C., 840 North Plankinton Avenue, MILWAUKEE, WI, 53203, US

(73) Assignee: Weather-Max LLC, Franklin, WI (US)

(21) Appl. No.: 12/283,367

(22) Filed: Sep. 11, 2008

(51) Int. Cl. E06B 7/14; E06B 7/16

(52) U.S. Cl. 52/209; 49/476.1

(57) ABSTRACT

An adjustable sill pan assembly that includes a sill pan formed of components engageable in a manner enabling length adjustment. The sill pan includes a rail that is adjustably engageable with corner pieces. In addition, the rail can be cut to length and coupled to another rail using a connector. A preferred pan rail includes an upraised back dam flange and a sill overlying panel over which a wicking sill liner is placed for enabling moisture in the region of the pan between a sill and window to be expelled. One or more spacers carried by the back dam flange bear against an interior surface of the window frame to maintain a flow channel between the back dam and window further facilitating moisture removal. The pan assembly can be used in conjunction with liquid and gas impervious tape to prevent infiltration. One preferred pan assembly embodiment is of caulk-free installation.

### CROSS-REFERENCE

This application claims the benefit under 35 U.S.C. §119(e) of U.S. Provisional Application Ser. No. 60/993,293, filed Sep. 10, 2007, the entirety of which is expressly incorporated by reference herein.

### FIELD

The present invention relates to a sill pan assembly and more particularly to a sill pan assembly that is adjustable including by being customizable for sills of different lengths, widths and configurations and that can be part of a system for sealing against intrusion of elements in windows, doors, etc. using the system.

### BACKGROUND

There are many sill pan arrangements out there claiming to stop water and air infiltration in the space between a window or door sill and its outer frame, in reality most do not do a very good job for a variety of reasons. Many are ill-fitting such that they are unable to accommodate variation in sill shape and contour that is normal from one sill to the next, resulting in air and water infiltration occurring anyway. Others are not adjustable so they cannot be properly fitted to the window or door sill with which they end up being used such that they do not prevent water and air infiltration from occurring either. Unfortunately, even where adjustable, nearly all sill pans lack any means to facilitate drainage of any liquid or moisture that does end up getting between the sill and pan, such that they can actually exacerbate the very problem they were created to remedy.

What is needed is a sill pan arrangement that is cost-effective to ship, easy to assemble, provides good sealing and which enables moisture in the sill and frame to escape.

### SUMMARY

The present invention is directed to an adjustable sill pan assembly that includes a sill pan arrangement of adjustably buildable construction that cooperates with a sill pan liner to help drain moisture and liquid that might accumulate in the sill region between a window or door sill and a window or door installed in the sill. The adjustable sill pan assembly can cooperate with a sealing or flashing tape in a sill pan assembly system that further improves resistance to air, moisture and liquid infiltration. In a preferred embodiment, such a sill pan assembly system can be of peel-and-stick construction enabling quick and easy assembly of the pan assembly and tape in the sill.

One preferred sill pan arrangement includes at least one sill pan rail of elongate construction that has an upraised back dam flange that defines a flow channel between an interior window or window frame surface that can collect moisture or liquid flowing down a window on its interior side. The back dam flange can include one or more spacers can be of clip on or attachable construction that further facilitate spacing of the back dam flange from the window in defining such a flow channel. In a preferred embodiment, the flow channel can communicate liquid received therein to the sill pan liner with a preferred sill pan liner embodiment including wicking material that wicks moisture and liquid in the sill pan region away.

The sill pan rail can also have a sill overlying panel that is downwardly sloped upon which at least part of the sill pan liner is disposed thereby causing gravity to complement wicking of moisture or liquid out of the sill pan region. In a preferred embodiment, the sill overlying panel has a pair of spaced apart ribs having different sizes that rest upon the sill imparting a desired downward slope to the upper surface of the sill overlying panel.

The back dam flange can be equipped with a channel that enables corner pieces to slidably engage the channel in a manner that forms a sill pan assembly whose length can be adjusted. In a preferred embodiment, the sill pan rail is of cut-to-length construction such that it further length adjustment can be carried out using the corner pieces. In a preferred embodiment, a connector can be used to couple together a pair of sill pan rails where additional length adjustment is needed to increase length.

Where a sealing or flashing tape is used, it can be and preferably is of water and air impervious construction to facilitate preventing air, water and moisture infiltration.

Other advantages, benefits and features of the present invention will become apparent to those skilled in the art upon reading the detailed description and viewing the related drawings.

### DRAWING DESCRIPTION

One or more preferred exemplary embodiments of the invention are illustrated in the accompanying drawings in which like reference numerals represent like parts throughout and in which:

FIG. 1 is a perspective view of a preferred embodiment of an adjustable sill pan assembly constructed in accordance with the present invention that has been installed in a sill of a window;

FIG. 2 is an exploded view of a preferred embodiment of an adjustable sill pan assembly that is usable with a infiltration barrier system in a sill pan drainage system of the invention;

FIG. 3A is an enlarged fragmentary perspective view of a first preferred embodiment of a sill pan rail that is a component of the adjustable sill pan assembly;

FIG. 3B is an side elevation cross section view of a second preferred embodiment of a sill pan rail;

FIG. 4 is an enlarged perspective view of a sill pan rail connector enabling coupling of a plurality of sill pan rails of one implementation of a preferred embodiment of the adjustable sill pan assembly;

FIG. 5 is an enlarged perspective view of a sill pan corner piece of the adjustable sill pan assembly;

FIG. 6A is an enlarged fragmentary perspective view of an embodiment of a spacer used to engage a portion of the sill pan rail in a manner that maintains spacing between a back dam flange of the sill pan rail and an interior facing surface of a window frame received in the sill pan to create a fluid flow channel therebetween;

FIG. 6B is a front elevation view of a preferred embodiment of a spacer also configured to engage a portion of the sill pan rail in a manner that maintains spacing between a back dam flange of the sill pan rail and an interior facing surface of a window frame received in the sill pan to create a fluid flow channel therebetween;

FIG. 6C is a side elevation view of the spacer shown in FIG. 6B;

FIG. 7 is a perspective view of a sill corner joint cap capable of being used with or as part of at least one implementation of the adjustable sill pan assembly;

FIG. 8 is a perspective view of a window opening in an exterior wall of a building that has been prepared for sill pan and window installation;

FIG. 9 is a front elevation view of the window opening of FIG. 8 covered with a building wrap that is cut away to expose the window opening in preparation for sill pan and window installation;

FIG. 10 is a partial fragmentary perspective view of a portion of the window opening showing the sill receiving a pair of sill corner joint caps;

FIG. 11 is an exploded perspective view of one preferred implementation of an adjustable sill pan arrangement of the sill pan assembly;

FIG. 12 is an enlarged exploded fragmentary perspective view of a corresponding encircled portion of FIG. 11 showing assembly of the sill pan rail connector in joining a pair of sill pan rails;

FIG. 13 is an enlarged exploded fragmentary perspective view of a corresponding encircled portion of FIG. 11 showing assembly of a sill pan corner piece to one end of a sill pan rail;

FIG. 14 is an enlarged fragmentary perspective view of the sill having an assembled adjustable sill pan arrangement received in the sill;

FIG. 15 is an enlarged fragmentary perspective view of the sill showing an installation step that includes positioning a layer of a sealing or flashing tape over a bottom portion of the window opening and sill;

FIG. 16 is an enlarged fragmentary perspective view of a portion of the sill showing attachment of a portion of the layer of the sealing or flashing tape over part of the sill and part of a sill pan rail of the assembled sill pan arrangement;

FIG. 17 is an enlarged fragmentary perspective view of another portion of the sill showing attachment of another layer of a sealing or flashing tape over a sill corner joint cap and a portion of a sill pan rail of the assembled sill pan arrangement;

FIG. 18 is an enlarged perspective view of the sill having a wicking sill liner overlying at least one or both of the layers of sealing or flashing tape and/or the assembled sill pan arrangement;

FIG. 19 is an enlarged perspective view of the window opening and sill with the sill pan assembly installed in the sill illustrating placement of bead of caulk or sealant about an inner peripheral surface of the window opening to provide back caulking of an outer peripheral flange of a window installed in the window opening;

FIG. 20 is an enlarged perspective view of a window installed in the window opening with its outer peripheral flange sealed against the bead of caulk or sealant of FIG. 19;

FIG. 21 is an enlarged perspective view of the window installed in the window opening with a plurality of strips or pieces of sealing or flashing tape applied about the outer peripheral flange taping the flange to outer sheathing of the outer wall that extends about the flange; and

FIG. 22 is an enlarged perspective view of the window installed in the window opening depicting a plurality of pairs of house wrap flaps folded over the tape strips or pieces and thereafter taped in place.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

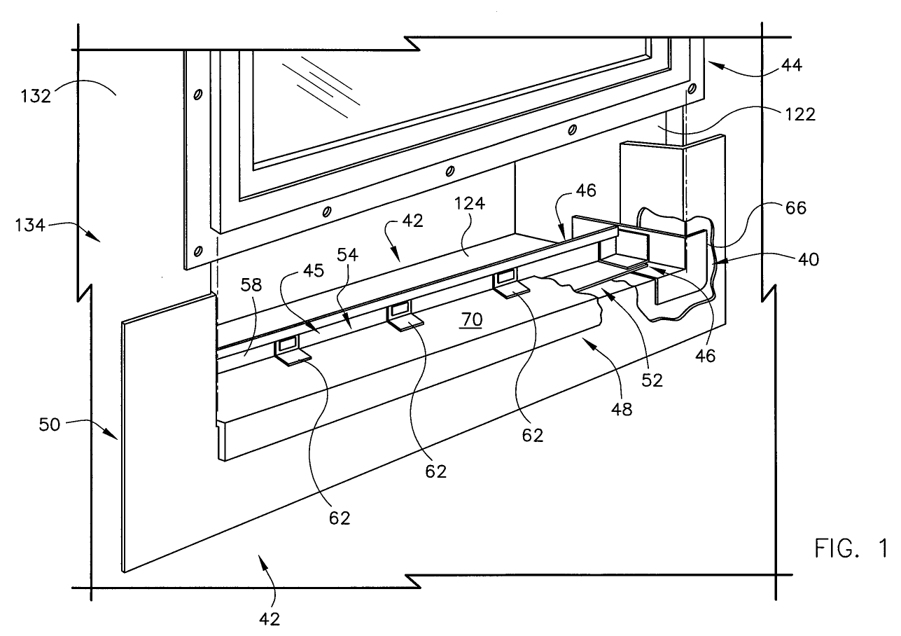

FIG. 1 illustrates a preferred embodiment of an adjustable sill pan assembly 40 constructed in accordance with the present invention that has been installed in a sill 42 of a window 44 prior to installation of a window 44. The sill pan assembly 40 includes an adjustably buildable pan subassembly 46 made of components that cooperate to enable adjustment to fit the particular sill 42 in which it is being installed and includes a sill liner 48 that enables drainage of moisture and water buildup in the sill region while opposing air infiltration. The sill pan assembly 40 advantageously offers caulk-less installation and is versatile in that it works in concert with current sealing or barrier systems, such as a sealing or flashing tape-type barrier system 50, which includes one or more sealing layers that work in concert with components of an installed sill pan assembly 40 in helping to prevent air and water infiltration. Although a window sill 42 and window 44 are shown in FIG. 1, it should be apparent that the present invention is also intended for use with door sills, doors, patio sills, patio doors and the like.

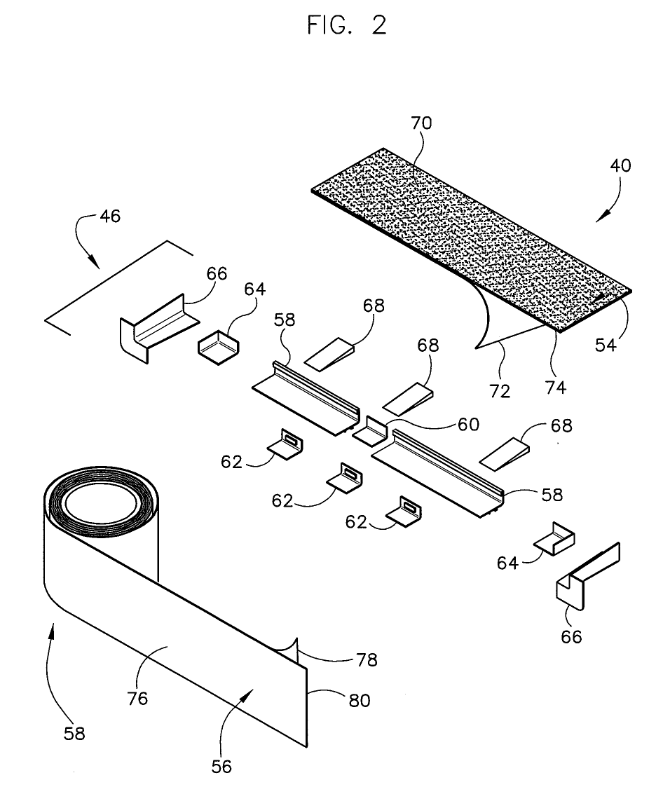

FIG. 2 illustrates the various components of the sill pan assembly 40 in more detail along with at least one component of barrier system 50 that can be used with the sill pan assembly 40 to help prevent infiltration. Various components of the adjustably buildable pan arrangement 46 are selected and assembled to form a sill pan 52 (FIG. 14) over which sill liner 46, which is or includes a layer of liquid wicking material 54, is placed. As previously mentioned, a barrier layer 56 made of one or more layers of sealing or flashing tape or the like can be used in concert with components of the sill pan arrangement 46. If desired, one or more barrier layers 56 of barrier system 50 can be applied to help seal and prevent infiltration.

The components of the adjustably buildable sill pan arrangement 46 include one or more elongate sill pan rails 58, a sill pan rail extender connector 60, one or more spacers 62, and a pair of sill pan end corner pieces 64, all of which can be used in conjunction with a pair of sill corner joint caps 66. If needed, one or more shims 68 can also be used to help level one or more various components, e.g., pan rail(s) 58 and/or corner piece(s) 64 when installed in sill 42. A sill pan 52 constructed in accordance with the present invention is formed from at least one pan rail 58 and a pair of pan end corner pieces 64 that each engages one end of pan rail 58 with at least a portion of each corner piece 64 overlying at least a portion of a corresponding sill corner joint cap 66, where sill corner joint caps 66 are used. Where desired or needed, one or more spacers 62 can be used. Where needed to extend overall pan length, connector 60 and a second pan rail 58 may be used. As previously discussed, where desired or needed, one or more shims 68 can be inserted between sill 42 and the bottom of a pan rail 58 and/or corner piece(s) 64.

The preferred sill liner embodiment shown in FIG. 2 includes a layer of wicking material 54 in the form of a rectangular mat 70 composed of a wicking fabric or the like that is capable of wicking water and other liquids via capillary action. In at least one preferred embodiment of a wicking mat 70, the wicking material or fabric is made of intertwined polypropylene fibers that acts as a one-way valve to wick moisture out from between the window 44 and sill 42. Such a polypropylene fiber wicking material advantageously will not rot and is mold and mildew resistant. The spacing, arrangement, size, construction and the like of the polypropylene fibers of the wicking material is configured to optimize wicking of moisture and water by the wicking mat 70 from the sill pan 52 in the region between sill 42 and window 44. To facilitate quick and easy application, the wicking mat 70 has a removable backing 72 that covers an adhesive layer 74 disposed along its backside. Such a backing 72 can be of peel-and-stick film or paper construction, if desired.

Where a barrier layer 56 is used, it preferably is or includes sealing tape or flashing tape 76, such as a door or window sealing or flashing tape, which has a removable backing 78 that covers an adhesive layer 80 disposed on its backside. Of course, such a backing 78 can be of peel-and-stick film or paper construction, if desired. Such sealing or flashing tape 76 preferably is made of a gas and liquid impermeable material so as to provide a gas and liquid impermeable seal where the tape 76 applied.

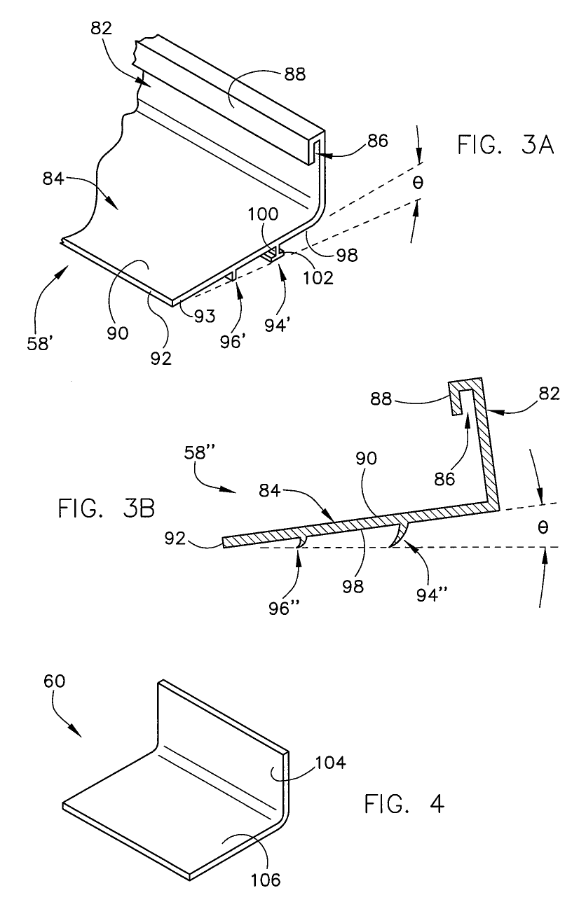

FIG. 3A illustrates in more detail one end and a segment of a preferred embodiment of pan rail 58′. Pan rail 58′ is of elongate construction, made of a water impervious material, such as plastic, like polypropylene, and can be formed by molding, such as by being extruded having a cross section throughout that is the same or substantially same along the entire length of the rail 58′ as that of the end of the rail 58′ shown in FIG. 3A. It is an advantage of the economical design of the pan rail 58′ shown in FIG. 3A that its width can be less than the width of the frame of a window 44 received in a sill 42 in which it has been assembled as part of sill pan 52.

Pan rail 58′ is of generally L-shaped construction having an upraised rear flange 82 from which an elongate sill overlying panel 84 generally transversely extends. The rear flange 82 serves as a back dam against which part of the frame of window 44 is disposed when window 44 is installed in sill 42. The purpose of such a back dam flange 82 is to oppose flow of air and water between the sill 42 and window 44 along the interior-facing side of the window 44 as well as to channel moisture and/or water from the interior-facing side of window 44 back toward the exterior-facing side of wall 134.

The back dam flange 82 also includes a channel 86 that can receive a complementarily formed portion of connector 60 or pan end corner piece 64 as discussed in more detail below. Such a channel 86 is disposed at least at each end of back dam flange 82 and extends along at least a portion of the flange 82 away from one flange end. In the preferred embodiment shown in FIG. 3A, the channel 86 is integrally formed as part of the back dam flange 82 such that extends along the entire length of the flange 82 with the channel 86 being defined by a downturned lip 88 that is folded over onto part of flange 82.

The sill overlying panel 84 defines a base of the pan rail 58 such that it can rest uprightly on the panel 84 when placed in the sill 42. The sill overlying panel 84 has a top pan rail surface 90 that slopes at least slightly downwardly from the back, at or adjacent the back-dam flange 82, toward a front pan rail edge 92 to employ gravity to encourage flow of liquid that ends up in the region above the top surface 90 as well as on the top surface 90 away from the interior-facing window side toward the exterior-facing window side. The generally planar nature of the top pan rail surface 90 helps facilitate receipt or attachment of a barrier layer 56 and/or sill liner 46. For example, one or more layers of sealing or flashing tape 76 and/or a portion of a wicking mat 70 can be attached thereto or otherwise disposed thereon either singly or in concert.

To cause the top pan rail surface 90 to be downwardly sloped when installed in sill 42, there are a plurality of spaced apart pan rail spacer ribs 94′, 96′ that extend outwardly from a bottom pan rail surface 98 with the rearward-most located one of the ribs 94′ having a greater height than a forward-most located one of the ribs 96′. As is shown in FIG. 3A, the rearward-most located rib 94′ is generally upside-down T-shaped having a downwardly extending flange 100 terminating in a foot 102 of increased surface area that can better support the weight of window 44 and its frame resting on sill 42 while still imparting a desired downward slope to the top pan rail surface 90. The forward-most located pan rail rib 94′ is a generally downwardly extending flange or finger but can have a different cross-sectional shape or configuration if desired.

FIG. 3B illustrates a transverse cross section of a second preferred embodiment of pan rail 58″ where the downward slope-imparting spacer ribs 94″, 96″ have a different cross-sectional configuration than the ribs 94′, 96′ shown in FIG. 3A. In this preferred embodiment, both ribs 94″, 96″ are barb-shaped or generally C-shaped flanges such that their tips are canted or otherwise inclined forwardly of where each attaches to the bottom 98 of the pan rail 58″. Such forwardly inclined or canted spacer ribs 94″, 96″ can help facilitate receipt of a shim 68 between it and sill 42, where shimming is employed.

In either case, each rib 94′, 96′ or 94″, 96″ projects downwardly a respective distance imparting an angle, θ, of downward slope to the top pan rail surface 90 that achieves a downward slope of between one sixteenth of an inch and one eighth of an inch to more optimally encourage gravity to cause moisture and water to flow away from back dam flange 82 toward the exterior-facing side. In either case, ribs 94′, 96′ or 94″, 96″ can be and preferably are integrally formed with the pan rail 58′ or 58″ such that a pan rail 58′ or 58″ of one piece, unitary and substantially homogenous construction results.

At least the sill overlying pan rail panel 84 has a relatively thin cross-sectional thickness. Where made of plastic, such as polypropylene, this imparts a desired amount of flexibility to the sill overlying panel 84 enabling it to better conform to contour variations of sill 42 both along the length of the sill and in a front-to-back direction. This flexible construction helps to optimize the ability of the pan rail 58 to fit the particular sill 42 and oppose air and water infiltration by minimizing the likelihood of any gaps being formed, which can happen with certain types of prior art sill pans. The back dam flange 82 also has a similar cross sectional thickness and is configured to enable it to resiliently bear against a backside surface of the frame of window 44 in a manner that also helps it to conform and better seal against it.

In one embodiment, the cross-sectional thickness of the sill overlying panel 84 is no greater than about two millimeters (about 0.08 inches). In one preferred embodiment, the cross-sectional thickness of the sill overlying panel 84 is about one millimeter (about 0.04 inches) with the cross-sectional thickness of that part of the upwardly extending back dam flange 82 below the channel 86 having the same or about the same cross-sectional thickness.

With reference to FIGS. 4, 11, and 12 where the window or door sill has a length greater than that of a pre-cut section of pan rail 58, a generally L-shaped pan rail extender connector 60 is used to couple a pair of pan rails 58 together. The connector 60 is made of a material that is the same or similar as pan rail 58 with it having an upright flange 104 joined to an outwardly extending generally horizontal flange 106. At least the upright flange 104 has a relatively thin cross-sectional thickness that is thin enough so as to be slidably received in channel 86 of pan rail 58. In one preferred embodiment, connector 60 is used to couple a pair of pan rails 58 where the length of sill 42 is greater than six feet.

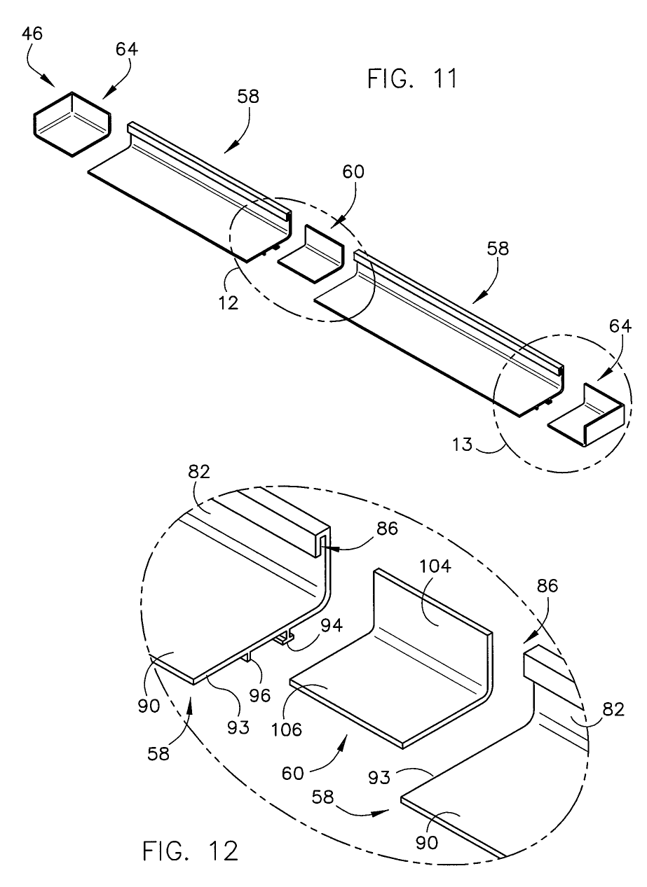

In use, with specific reference to FIGS. 11 and 12, one side of the upright flange 104 of the connector 60 is slidably received in channel 86 of one pan rail 58 and the other side of the upright flange 104 is received in channel 86 of an adjacent pan rail 58 enabling the pan rails 58 to be coupled together by connector 60 in a manner where their adjacent ends 93 can abut. The result is a pair of pan rails 58 coupled together by connector 60 such that they appear and behave as or like a single panel rail of extended length.

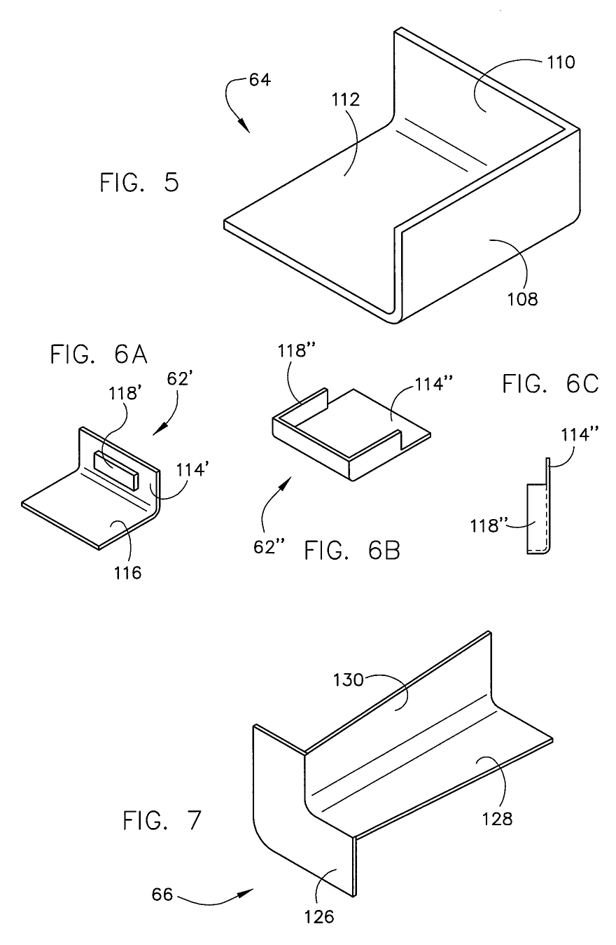

With reference to FIGS. 5, 11, 13, and 14, each pan end corner piece 64 has a construction similar to that of connector 60 but further includes an upraised end wall flange 108 that defines an end wall of the resultant pan 52 (FIG. 14) formed when assembly of all of the components is finished. The corner piece 64 also has an upright connecting flange 110 that is received in a channel 86 located at one end of a pan rail 58 and has an outwardly extending flange 112 that overlies the sill overlying panel 84 of the pan rail 58 when the corner piece 64 is engaged with pan rail 58. The end wall flange 108 interconnects with the other two flanges 110, 112 in the manner best shown in FIG. 5, forming a corner piece that can be and preferably is of one-piece, unitary and substantially homogenous construction being formable of the same type of material as that of pan rail 58.

As is best shown in FIGS. 11, 13 and 14, upright flange 110 of corner pieces 64 is slidably received in the channel 86 of a corresponding end of pan rail 58. Where composed of a pair of pan rails 58 coupled by connector 60, the connecting flange 110 of one corner piece 64 is received in channel 86 of one pan rail 58 and the connecting flange 110 of the other corner piece 64 is received in channel 86 of the other pan rail 58.

As a result of this sliding, telescopic engagement when the upright connecting flange 110 is received in channel 86, it advantageously permits adjustment of the total pan length so it is the same as the length of the actual sill 42 in which installation is occurring. Such an adjustable pan assembly construction advantageously accommodates significant variations in sill length and construction as what is typically found in building structures.

With reference to FIGS. 6A and 18, a plurality of spacers 62′ disposed in engagement with frame rail 58 can have a portion that is placed over wicking mat 70 with each spacer 62′ configured to help space the back dam flange 82 from the interior-facing side of the frame of window 44 so as to enable any water flowing downwardly to be directed by the flange 82 toward the wicking mat 70 so it is expelled toward the exterior-facing side, e.g., exterior wall 134. Use of these spacers 62′ to maintain spacing of back dam flange 82 along the interior facing side of window 44 so as to form a fluid-receiving channel 45 (FIG. 1) therebetween advantageously enables a pan assembly constructed in accordance with the present invention using such spacers 62′ to withstand hurricane force winds and the rain that typically accompanies such conditions.

The spacer 62′ shown in FIG. 6A has an upright spacer tab 114′ a portion of which is received in channel 68 of pan rail 58 with another portion 118′ that can bear part of the interior facing side of the frame of window 44 to keep the back dam flange 82 spaced a distance from an interior facing side of the frame of the window 44. This forms the aforementioned fluid-receiving channel therebetween. The spacer 62′ can also have an outwardly extending tab 116 that overlies wicking mat 70 when spacer is engaged to a pan rail 58. FIGS. 6B and 6C illustrate a preferred embodiment of a spacer 62″ that includes an upwardly extending spacer tab 114″ that is received in channel 82 of pan rail 58 and an outwardly extending spacer flange 118″ that abuts against the interior facing side of the window frame spacing the back dam flange 82 therefrom defining the fluid-receiving channel therebetween.

With reference to FIGS. 7, 14, and 17, if desired, the corner sill joint 120 formed between each uprightly extending sill side rail 122 and the horizontally extending sill bottom rail 124 can be covered by a sill corner cap 66, which can be of one-piece, unitary and homogenous construction that can also be made of the same material as that of the pan rail 58. The cap 66 includes a front or outer flange 126 from which a pair of walls 128, 130 extends in a generally L-shaped arrangement. The corner cap flange 126 abuts against part of an outer panel 132, e.g., sheathing, of the exterior wall 134 adjacent the sill 42 locating the corner cap 66 such that one wall 128 rests on or overlies part of the horizontal sill rail 124 and the other wall 130 rests against or otherwise overlies part of the vertical sill rail 122 securely covering and protecting the joint 120 therebetween preventing infiltration therein.

Where a corner joint cap 66 is not used, each joint 120 can be and preferably is covered with a piece of sealing or flashing tape or the like to seal the joint 120. In another embodiment, a corner cap 66 can be placed over at least one layer of sealing or flashing tape covering each joint 120, which can provide additional infiltration protection.

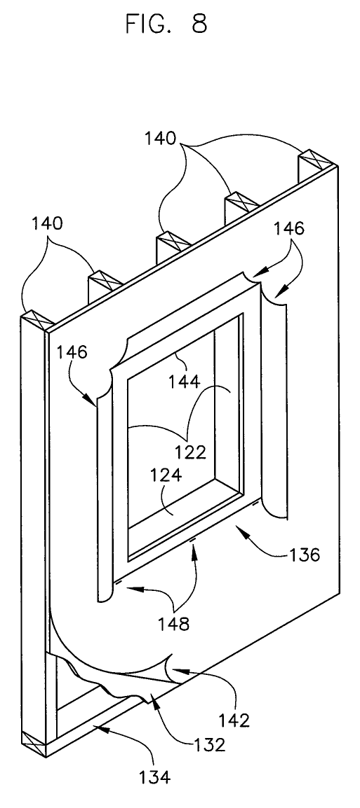

FIGS. 8-22 illustrate at least one preferred implementation of a method of installing a sill pan assembly 40 constructed in accordance with the present invention. FIG. 8 illustrates a generally rectangular or square opening 136 formed in a wall 134 of a building, such as a house under construction, which is sized to accept a frame 138 of a window 44. The wall is defined by outer wall sheathing 132, such as a sheet of oriented strand board or the like, at least part of which is cut out to form at least part of window opening 136. The wall 134 is supported by a plurality of pairs of spaced apart and vertically extending studs 140 that can be of wooden or metallic construction. Overlying the outer sheathing 132 is a relatively thin layer of air and/or water infiltration resistant material 142 in the form of a building or house wrap material, such as TYVEK, PINKWRAP, or the like. Bounding the periphery of the window opening 136 is a sill 42 that is defined by a generally horizontally extending bottom rail 124, a pair of spaced apart and vertically extending side rails 122, as well as a generally horizontally extending top rail 144.

While a window sill is shown in FIG. 8, it should be noted that a sill pan assembly 40 constructed in accordance with the present invention is also well suited for other types of openings and sills. For example, a sill pan assembly 40 constructed in accordance with the present invention, is well suited for use with a similar type opening configured to accept a door or the like. In addition, a sill pan assembly 40 constructed in accordance with the present invention is also particularly well suited for a larger sill of an opening configured for receiving relatively large windows, including sliding patio windows/doors.

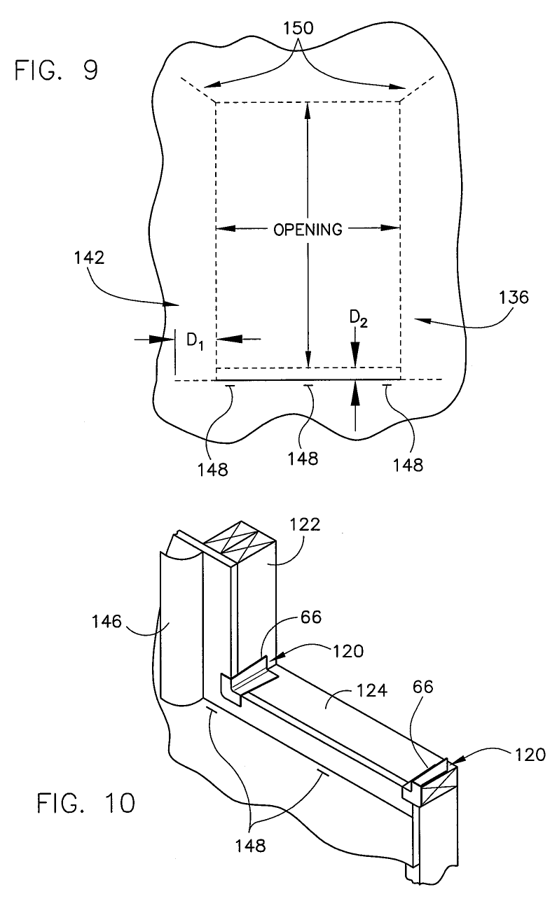

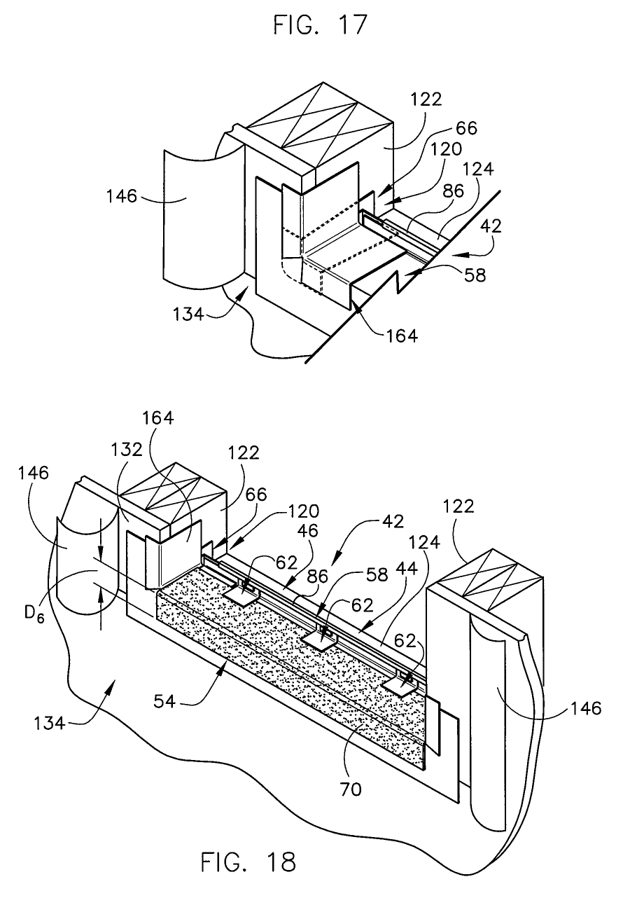

With additional reference to FIG. 9, the house wrap 142 is cut or otherwise sliced along the sides of the window opening 136 from the top to approximately two inches below the bottom of the opening. In addition, the house wrap 142 is cut across the top of the opening 136 as well as along the bottom of the opening 136 with a diagonally extending slit 150 at each upper corner allowing a flap 146 of house wrap material to be folded back along the top and sides of the window opening a distance, D₁, of about six inches. The bottom flap preferably is cut away and removed a distance, D₂, of about two inches below the bottom of the window opening 136 as shown in FIG. 8 with the remaining house wrap that extends along the bottom of the window opening being attached to the outer wall panel 132 using a plurality of fasteners or the like, such as staples 148.

Where corner caps 66 are used, one corner cap 66 is placed in one bottom sill corner joint 120 and the other corner cap 66 is placed in the other bottom sill corner joint 120 in the manner shown in FIG. 10. It should be noted that there are different sizes of corner caps 66 depending upon the type and size of window or door with which the corner cap 66 is being used. Although a corner cap 66 is shown in FIG. 10, another type of sill corner joint cap or cover (not shown) can be used. In addition, as previously discussed above, each corner joint 120 can be covered using a layer of flashing tape, a layer of window or door sealing tape, or the like, such as is depicted in FIG. 17. If desired, another type of joint sealer or joint sealing arrangement can be used in addition to in lieu of corner caps 66.

With reference once again to FIG. 11, components of the adjustably buildable pan arrangement 46 are selected depending upon the width of the window sill opening. The components of the adjustably buildable pan arrangement 46 can be prepackaged in a kit that includes wicking sill liner 48 (not shown in FIG. 11). If desired, such a prepackaged kit can include one or more components of barrier system 50 (also not shown in FIG. 11).

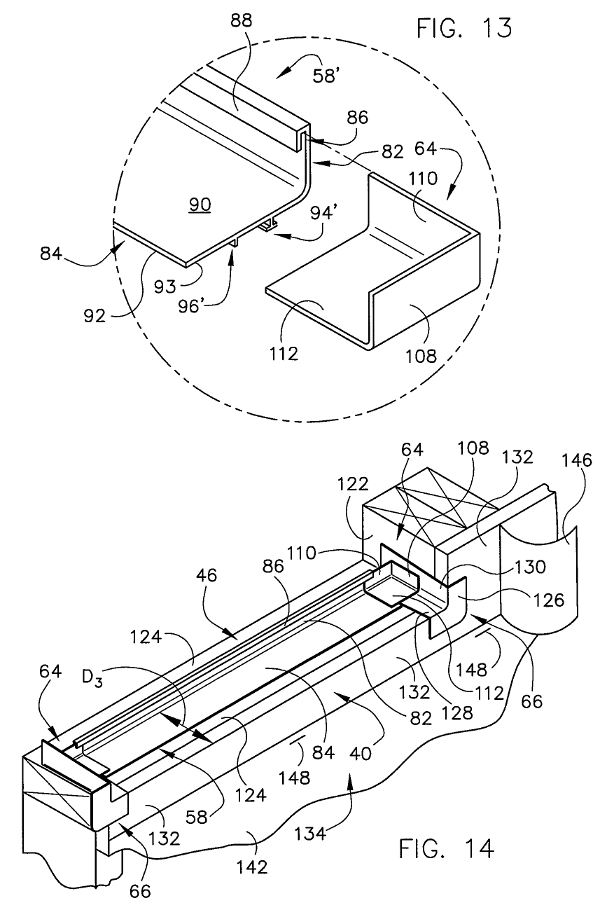

In preparation for assembling the pan arrangement 46, a single pan rail 58 or a plurality of pan rails 58 is selected depending upon the width of the window sill opening. Depending upon the length required, one or both sections of pan rail 58 can be cut to size, such as by using a utility knife or the like, such that overall pan rail length is about one quarter of an inch shorter than that of the window sill opening. Where the width of the window sill opening requires the usage of a pair of pan rails 58, connector 60 is used in a manner shown in FIG. 12 to couple the pan rails 58 together. In addition, as is shown in FIG. 13, an end corner piece 64 is slidably, telescopically, attached to each pan rail end. Where a connector 60 is used, the end corner pieces 64 can be attached before or after connector 60 is used to couple pan rails 58 together.

Thereafter, with reference to FIG. 14, the assembled pan arrangement 46 is placed in the sill 42 such that the outwardly extending back dam flange 82 of pan rail(s) 58 is generally spaced a distance, D₃, that is approximately equal to the width or depth of the window 44, e.g., window frame, which will be subsequently inserted into the window opening 136. If desired, a plurality of pairs of fasteners (not shown), e.g. staples, can be used to anchor various components, e.g. pan rail(s) 58 and/or end corner piece(s) 64, to the underlying horizontal bottom sill rail 124. When the assembled pan arrangement 46 is placed in the sill 42, a portion of each end corner piece 64 extends outwardly from a corresponding pan rail end thereby overlying and being supported by horizontal wall 128 of a corresponding sill corner cap 66. As a result being supported by sill corner cap horizontal wall 128, due to its thickness, the entire generally horizontally extending surface of the assembled pan arrangement 46, including sill overlying panel 84 of pan rail(s) 58 and outwardly extending horizontal flange 112 of each end corner piece 64, is generally planar and remains generally planar even when supporting at least a portion of the weight of a window 44 disposed in the sill 42.

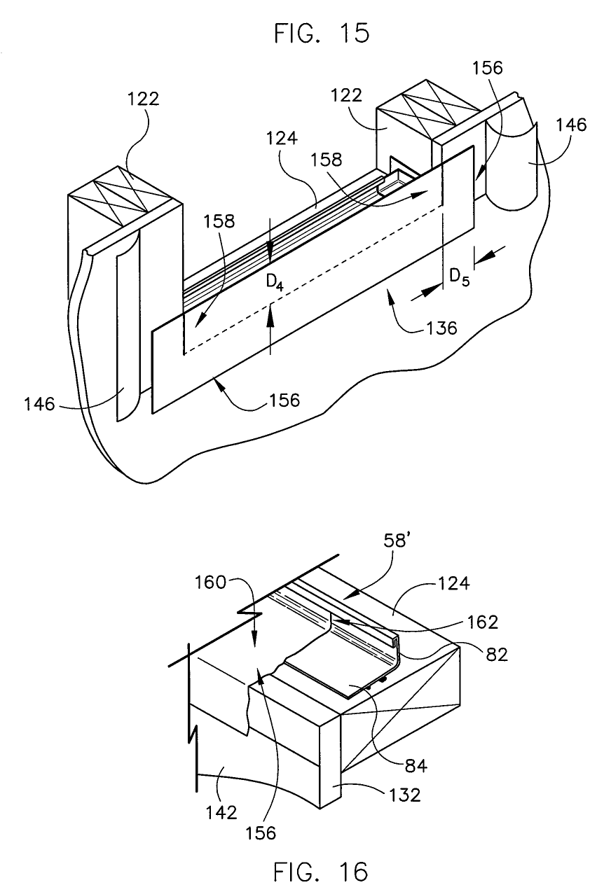

With reference to FIGS. 15 and 16, a piece or strip of sealing or flashing tape 156, which can be a window tape, door tape or another type of suitable sealing/flashing tape or the like, is applied in the manner shown in FIG. 15 such that the tape 156 overlies a bottom portion of the window opening 136 enough distance so that when cut 158 along each side as shown, the resultant flap 160 is pressed down such that it adheres to both the bottom sill rail and at least a portion of the sill overlying panel 84 of pan rail(s) 58. As shown in FIG. 16 at least a portion of the tape 156 is attached to back dam flange 82 at 162 to better water-tightly seal the sill pan region. It also overlaps house wrap 142 to ensure moisture being discharged from the sill pan 52 toward the exterior side cannot flow into the space between the house wrap 142 and sheathing 132. It can also be attached to a portion of each end corner piece 64 as well. This not only helps secure the assembled sill pan arrangement 46 in place, and also advantageously helps ensure that no liquid or moisture can flow underneath any portion of pan arrangement 46 or underneath the adjacent house wrap 132. In a currently preferred implementation of a method of installation in accordance with the present invention, such a piece of flashing tape, window tape, door tape or the like is indeed used in the manner depicted in FIGS. 15 and 16.

In the preferred implementation depicted in FIGS. 15 and 16, the piece or strip of tape 156 overlies the opening a distance, D₄, of at least about the depth or width of the window 44, including its frame width. In one preferred implementation, D₄, includes an additional one-half inch such that the piece or strip of tape 156 overlies the bottom of the window opening a distance, D₄, equal to approximately the depth or width of the window 44, including frame width, plus an additional one-half inch. As is also shown in FIG. 15, the piece or strip of tape 156 extends beyond each side of the opening by a distance, D₅, of at least about two inches and preferably about three inches.

With reference to FIG. 17, an additional piece or strip of such tape 164 can be and preferably is secured to a portion of each vertical sill rail 122 and to a portion of the piece or strip of tape 156 previously applied on the horizontal bottom sill rail 124 and sill pan arrangement 46. This advantageously helps ensure that any moisture or liquid that makes its way along or adjacent to the sill joint 120, including along the portion of the vertical sill rail 122 adjacent thereto, will flow downwardly due to the force of gravity toward the sill pan arrangement 46 and onto and/or into wicking mat 70 (FIG. 18) where it is wicked away.

Thereafter, as is depicted in FIG. 18, a layer of liquid wicking material 54 is applied onto any sealing or flashing tape 156 and/or 164 and/or onto the sill 42 and at least part of the sill pan arrangement 46. In the preferred implementation depicted in FIG. 18, the layer of wicking material 54, i.e., wicking mat 70 is applied over the sealing or flashing tape pieces or sections previously applied. The width of the wicking mat 70 selected enables a portion of the mat 70 to extend downwardly a distance, D₆, of at least two inches so that it overlies sealing or flashing tape 156 applied to outer wall sheathing 132. This advantageously produces a sill pan assembly 40 that not only minimizes liquid, moisture and air infiltration but also enables any liquid or moisture that enters the sill region between the bottom of the frame of window 44 and sill 42 to be expelled due to capillary action of the wicking material of the wicking mat 70 acting in concert with gravity.

The resultant sill pan assembly 40 constructed in accordance with the present invention advantageously is more robust than other prior art sill pans as it better conforms to the contours and other variations in window and door sills, better opposes and prevents water, moisture and air infiltration, enables quick drainage of any infiltrated water and moisture preventing mold and mildew from developing and is a pan assembly 40 that is of caulk-less construction but which conveniently permits or accommodates window bottom flange back caulking to maintain compliance with window manufacturer warranties. In fact, a sill pan assembly 40 constructed in accordance with the present invention needs no primer; spray tack, caulk or sealant as part of its assembly.

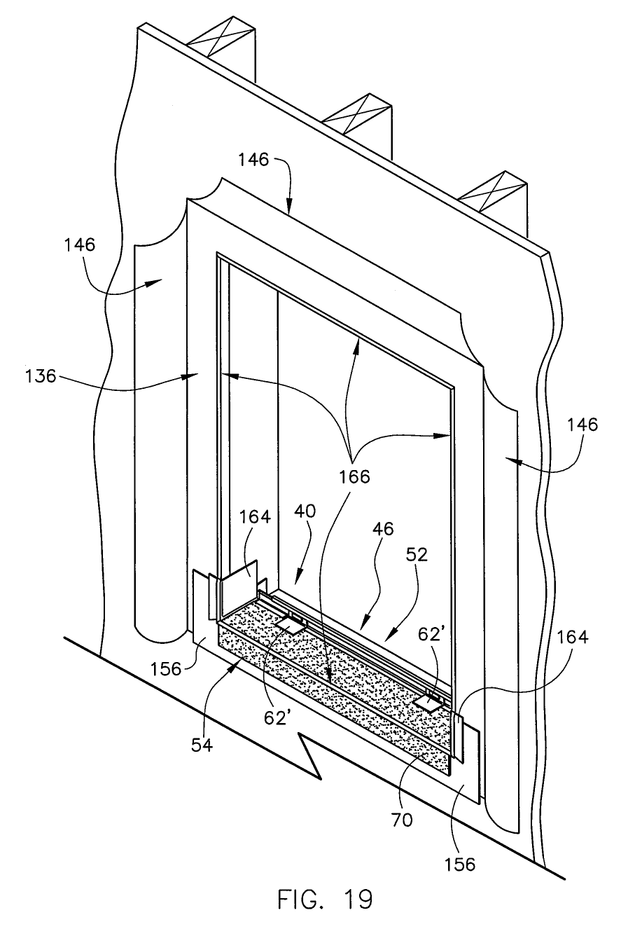

As mentioned in the preceding paragraph, a bead of a sealant or caulk 166 can be applied about the perimeter of the opening in the manner depicted in FIG. 19. If shimming is required, one or more shims can be inserted as needed between the bottom of pan rail 58 and sill along the length of the pan assembly from the interior-side in a manner known in the art. Shimming can be done before application of sealant or caulk, but is typically done after sealant or caulk.

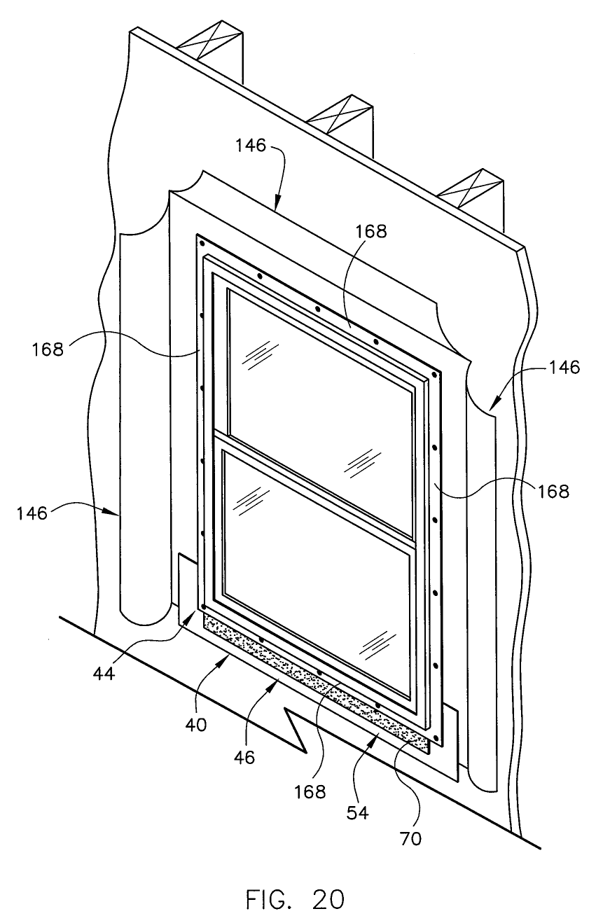

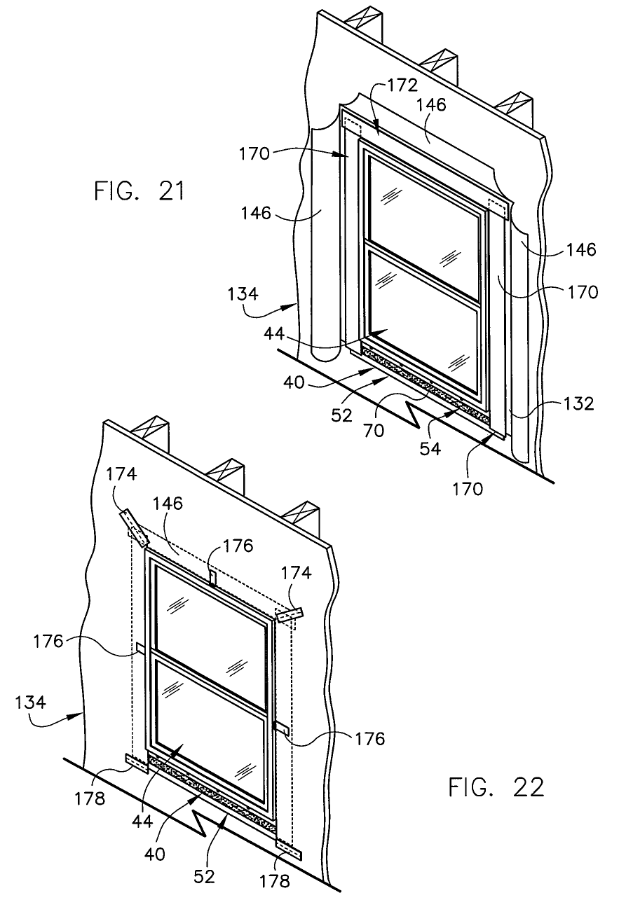

Thereafter, with reference to FIG. 20, the window 44 is placed in the window opening with its outer flange 168 coming into contact with any bead of sealant or caulk 166 that has been applied. The window 44 is leveled and squared before being fixed or otherwise permanently mounted using fasteners such as nails or the like. To the extent needed or desired, layers of sealing or flashing tape 170, 172 can be applied along the top, bottom and both sides of the window 44 such that the tape extends over the window flange 168 and onto the surrounding sheathing 132 as depicted in FIG. 21. The sides are preferably taped first with the top taped thereafter such that any strip or piece of tape 172 extending along the top overlaps each top edge of each strip or piece of tape 170 extending along each respective side. Although not shown, the window flanges 168 are top nailed to the sheathing 132 after this taping step is completed.

With reference to FIG. 22, the house wrap flaps 146 are folded over (1) the top window flange 168 and any applied sealing or flashing tape 172 and (2) each side window flange 168 and any applied sealing or flashing tape 170. Finally, the downwardly folded flaps are each taped using a plurality of pieces of sealing or flashing tape 174, 176, and 178 as shown in FIG. 22. Siding or another covering (not shown) placed over the outer wall 134 will cover the portion of the wicking mat 70 that extends downwardly along the wall 134 as will be done in completing the building in which window 34 has been installed.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A sill pan assembly for installation in a door or window sill comprising a size adjustable sill pan arrangement.

2. The sill pan assembly of claim 1 wherein the size adjustable sill pan arrangement comprises a plurality of components that are assembled and installed in the door or window sill without using any caulk or sealant to keep the sill pan components assembled or to install the sill pan components in the door or window sill.

3. The sill pan assembly of claim 2 wherein the sill pan components define a sill pan arrangement in which a window or door is disposed with at least a portion of the sill pan arrangement being comprised of a region of the sill bounded by the sill pan components.

4. The sill pan assembly of claim 3 further comprising a sill liner overlying the sill pan components and the region of the sill bounded by the sill pan components.

5. The sill pan assembly of claim 4 wherein the sill pan liner is comprised of a liquid wicking material.

6. The sill pan assembly of claim 2 wherein the sill pan components comprise a sill pan rail and a plurality of end corner pieces that can adjustably engage the sill pan rail in a manner that enables adjustment of sill pan length.

7. The sill pan assembly of claim 6 wherein the sill pan rail comprises a channel and each one of the end corner pieces comprises a flange slidably receivable in the channel.

8. The sill pan assembly of claim 6 wherein the sill pan rail is of cut-to-length construction.

9. The sill pan assembly of claim 1 wherein the sill pan arrangement comprises an elongate sill pan rail having an upraised back dam flange and an outwardly extending sill overlying panel overlying a portion of the sill, a layer of a liquid and air impervious material overlying at least a portion of the sill overlying panel and another portion of the sill, and a sill liner comprised of a liquid wicking material overlying the layer of liquid and air impervious material and at least a portion of the sill overlying panel with the layer of liquid and air impervious material disposed therebetween.

10. The sill pan assembly of claim 9 wherein wicking sill liner comprises a generally rectangular wicking mat that has a generally horizontal portion overlying the layer of liquid and air impervious material and at least a portion of the sill overlying panel and a generally vertical portion overlying a portion of outer sheathing of an exterior wall bounding the window opening.

11. The sill pan assembly of claim 1 wherein the sill pan arrangement comprises an elongate sill pan rail having an upraised back dam flange and an outwardly extending sill overlying panel overlying a portion of the sill and a plurality of spacers disposed along at least a portion of the length of the upraised back dam flange that space the back dam flange away from a portion of the window defining a flow channel therebetween.

12. The sill pan assembly of claim 11 wherein each spacer comprises a component separate from the sill pan rail that engages the back dam flange in attaching each spacer thereto.

13. The sill pan assembly of claim 12 wherein the back dam flange comprises a channel and each spacer comprises a flange or tab that snaps into the channel in the back dam flange.

14. The sill pan assembly of claim 13 wherein each space comprises a forwardly extending spacer projection that faces toward an exterior side of the sill.

15. The sill pan assembly of claim 1 wherein the sill pan arrangement comprises an elongate sill pan rail having an upraised back dam flange and an outwardly extending sill overlying panel overlying a portion of the sill and wherein the sill overlying panel is downwardly sloped from adjacent an interior side of the sill toward an exterior side of the sill.

16. The sill pan assembly of claim 15 wherein the sill pan rail further comprises a pair of ribs extending outwardly from a bottom surface of the sill overlying panel downwardly sloping the sill overlying panel.

17. A sill pan assembly for installation in a door or window sill comprising:
a size adjustable sill pan arrangement installed in the sill;
a layer of wicking material disposed over at least a portion of the sill pan arrangement; and wherein the assembly installed in the sill comprised of the sill pan arrangement and wicking material layer is of caulk-free installation.

18. The sill pan assembly of claim 17 wherein the sill pan arrangement comprises a sill pan rail and a plurality of end corner pieces that each adjustably engage the sill pan rail in a manner that enables adjustment of sill pan assembly length.

19. The sill pan assembly of claim 18 wherein the sill pan rail comprises a channel and each one of the end corner pieces comprises a flange slidably receivable in the channel in a manner that enables adjustment of sill pan assembly length.

20. The sill pan assembly of claim 18 wherein the sill pan rail comprises an upraised back dam flange that further comprises a plurality of spacers that space the back dam flange from part of the window defining a fluid-receiving channel therebetween.

21. The sill pan assembly of claim 18 further comprising a layer of a water and air impervious material disposed between the layer of wicking material and at least a portion of the sill pan arrangement.

22. The sill pan assembly of claim 21 wherein the layer of a water and air impervious material also overlies at least a portion of the sill.

23. A sill pan assembly for installation in a door or window sill comprising:
a sill pan arrangement installed in the sill that comprises a sill pan rail having an upraised back dam flange and a sill overlying panel that is downwardly sloped; and
a layer of wicking material disposed over at least a portion of the downwardly sloped sill overlying panel.
